(19) United States
(12) Patent Application Publication
(10) Pub. No.: US 2025/0327891 A1
(43) Pub. Date: Oct. 23, 2025

(54) SPATIAL AREA LAYOUT RECONSTRUCTION BASED ON RADIO FREQUENCY MEASUREMENTS

(71) Applicant: QUALCOMM Incorporated, San Diego, CA (US)

(72) Inventors: Dimitrios KALATZIS, Amsterdam (NL); Tribhuvanesh OREKONDY, Wettingen (CH); Hanno ACKERMANN, Amsterdam (NL); Ilia KARMANOV, Amsterdam (NL); Farhad GHAZVINIAN ZANJANI, Almere (NL); Daniel Hendricus Franciscus DIJKMAN, Haarlem (NL); Arash BEHBOODI, Amsterdam (NL); Shreya KADAMBI, San Diego, CA (US); Fatih Murat PORIKLI, San Diego, CA (US)

(21) Appl. No.: 18/852,332

(22) PCT Filed: May 5, 2023
(86) PCT No.: PCT/US2023/066658

§ 371 Date: Sep. 27, 2024

(30) Foreign Application Priority Data
May 17, 2022 (GR) 20220100405

(51) Int. Cl. G01S 5/02; H04W 24/08

(52) U.S. Cl. CPC G01S 5/0252; H04W 24/08

(57) ABSTRACT

Certain aspects of the present disclosure provide techniques and apparatus for training and using machine learning models to predict a layout of a spatial area based on an input data set of samples from the spatial environment. An example method generally includes receiving an input data set including a plurality of samples from a spatial area. Each sample of the plurality of samples generally includes at least channel state information data. A machine learning model is trained to predict a layout of the spatial area based on the input data set. The predicted layout of the spatial area generally includes a plurality of bounding boxes defining different regions of the spatial area.

### CROSS-REFERENCE TO RELATED APPLICATIONS

This application claims priority to Greek patent application No. 20220100405, entitled “Spatial Area Layout Reconstruction Based on Radio Frequency Measurements,” filed May 17, 2022, and assigned to the assignee hereof, the entire contents of which are hereby incorporated by reference.

### INTRODUCTION

Aspects of the present disclosure relate to using machine learning to estimate the layout of a spatial area based on radio frequency measurements.

In a wireless communications system, information about the layout of a spatial area in which operations are performed and location estimation (e.g., relative to one or more network entities) within the spatial environment may be used for various purposes. For example, layout information and location estimates can be used to aid in identifying various parameters for subsequent transmissions in the wireless communications system, such as identifying one or more directional beams to use in communicating between a network entity (e.g., a base station) and a user equipment, to identify beamforming patterns to apply to allow for directionality in signal processing, and the like. In another example, location estimation can be used to detect entry and exit of devices into different areas (e.g., defined based on a radius from a given device). Layout information and location estimation can be used for many other purposes as well, such as emergency management within the spatial area, spatial management, and the like.

Generally, radio frequency measurements within a spatial area may differ due to various factors within the spatial area. For example, sources of radio frequency interference, such as interfering network entities, may affect radio frequency measurements in some parts of the spatial area. In another example, hard surfaces, such as walls, support columns, or the like may introduce variance, or noise, in radio frequency measurements obtained within the spatial area. Because radio frequency measurements are generally noisy, it may be difficult to accurately estimate the layout of the spatial area based on these radio frequency measurements alone.

### BRIEF SUMMARY

Certain aspects provide a method for training a machine learning model to predict the layout of a spatial area based on radio frequency measurements. An example method generally includes receiving an input data set including a plurality of samples from a spatial area. Each sample of the plurality of samples generally includes at least channel state information data. A machine learning model is trained to predict a layout of the spatial area based on the input data set. The predicted layout of the spatial area generally includes a plurality of bounding boxes defining different regions of the spatial area.

Certain aspects provide a method for predicting a layout of a spatial area based on radio frequency measurements. An example method generally includes receiving an input data set including a plurality of samples from a spatial area. Generally, each sample of the plurality of samples includes at least channel state information data. A layout of the spatial area is predicted based on a machine learning model and the received input data set. The layout of the spatial area generally includes a plurality of bounding boxes defining different regions of the spatial area. The predicted layout of the spatial area is output.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates radio frequency measurements in a spatial area and radio frequency measurements captured during traversal of a path in the spatial area.

FIG. 2 depicts an example representation of a point along a path in a spatial area, according to aspects of the present disclosure.

FIG. 3 depicts an example pipeline for predicting a layout of a spatial area based on a set of multidimensional samples representing data captured while traversing a path through the spatial area and a set predictor model, according to aspects of the present disclosure.

FIG. 4 depicts an example of a machine learning model that generates a representation for each sample in a set of multidimensional samples representing data captured while traversing a path through a spatial area, according to aspects of the present disclosure.

FIG. 5 depicts an example of a machine learning model that generates bounding boxes from representations of multidimensional samples representing data captured while traversing a path through a spatial area, according to aspects of the present disclosure.

FIG. 6 depicts a transformation of bounding boxes representing different portions of a spatial area into a layout of the spatial area, according to aspects of the present disclosure.

FIG. 7 depicts an example visual representation of time data used in predicting a layout of a spatial area, according to aspects of the present disclosure.

FIG. 8 depicts an example of a machine learning model that predicts a layout of a spatial area based on channel state information and a visual representation of time data, according to aspects of the present disclosure.

FIG. 9 depicts example operations for training a machine learning model to predict a layout of a spatial area based on an input data set of multidimensional samples from the spatial area, according to aspects of the present disclosure.

FIG. 10 depicts example operations for predicting a layout of a spatial area based on a machine learning model and an input data set of multidimensional samples from the spatial area, according to aspects of the present disclosure.

FIG. 11 depicts an example implementation of a processing system on which a machine learning model may be trained to predict a layout of a spatial area, according to aspects of the present disclosure.

FIG. 12 depicts an example implementation of a processing system on which a machine learning model may be used to predict a layout of a spatial area, according to aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques and apparatus for predicting a layout of a spatial area based on measurements obtained while traversing through the spatial area.

Information about the layout of a spatial area may be used for various tasks. For example, this information can be used to determine how a spatial area is to be used, to generate a virtual reality or extended reality scene in the spatial area, for traffic management within the spatial area, for location prediction, and the like. Location prediction, in turn, may be a powerful tool to aid in varying tasks. For example, active positioning may be used by a wireless device to predict its location in a spatial environment based on signals received from one or more transmitters (e.g., base stations, gNodeBs, etc.) in the spatial environment. Based on the predicted location, the wireless device can then identify parameters to use in wireless communications. For example, location estimation may allow for beamforming or beam selection to be performed in such a manner that maximizes, or at least increases, the strength of signaling received by a device in a wireless communication system (e.g., a UE). In another example, location estimation can be used in passive positioning. In passive positioning, a user equipment can use radio frequency measurements to predict positions of other devices in a spatial environment. Generally, the positions of other devices in a spatial environment can be based on perturbation to wireless signals caused by objects obstructing a direct line-of-sight path between a receiving device and a transmitting device.

Within a spatial environment, a wireless receiver can receive signaling from one or more transmitting devices, such as base stations, access points, relays, or the like. Due to various objects in the spatial environment and the resulting changes to signals caused by these objects (e.g., reflection, attenuation, interference, etc.), measurements, such as channel state information (CSI) measurements, may vary as the receiving device moves within the spatial environment (e.g., as a user of a mobile device moves within the spatial area). Because of the variance (or noise) in signal measurements that exists within a spatial environment, it may be challenging to reconstruct a layout of the spatial area using signal measurements alone. Further, because a path traversed through a spatial area may admit to many different layouts of the spatial area, information about the path alone may not be adequate for the reconstruction of a layout of the spatial area.

Aspects of the present disclosure provide techniques that allow for the use of signal measurements and other information to predict the layout of a spatial environment. Generally, the layout of the spatial area may include information identifying discrete portions of the spatial area (e.g., rooms in a building), openings between different portions of the spatial area (e.g., doorways or other open passageways), and the arrangement of these discrete portions of the spatial area. Because signal measurements generally provide some information about the spatial area, and because other information such as timing information derived from signal measurements and/or velocity and acceleration of a device that captures radio frequency measurements while traversing a path through a spatial area can also provide information about the spatial area, aspects of the present disclosure allow for the use of data captured along a path traversed through the spatial area in predicting the layout of the spatial environment. Thus, to predict the layout of a spatial area, a subset of the possible points in the spatial area may be sampled, which may reduce the amount of time and data used to predict the layout of the spatial area.

### Example Radio Frequency Measurements in a Spatial Area

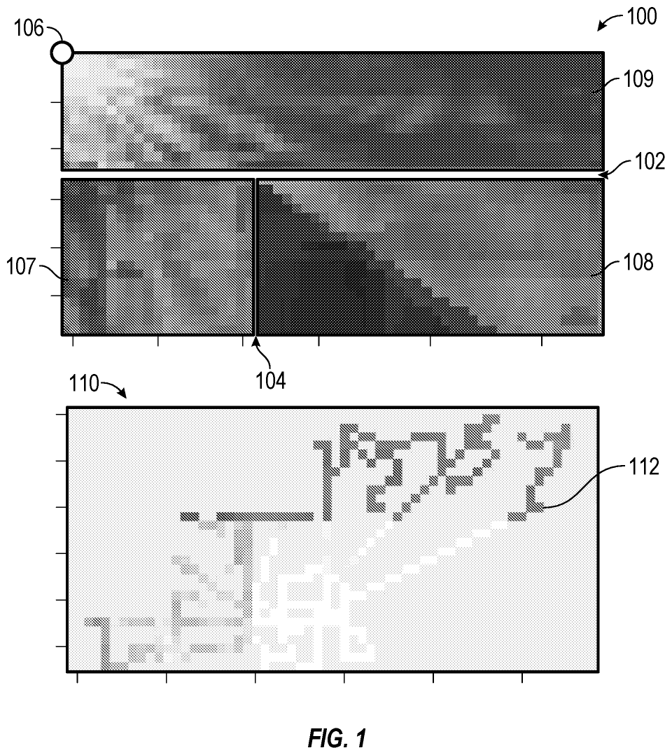

FIG. 1 illustrates an example of radio frequency measurements in a spatial area and radio frequency measurements captured during traversal of a path 112 in the spatial area.

As illustrated, a measurement map 100 illustrates radio frequency measurements at each point in the spatial area. For simplicity of illustration, the measurement map 100 assumes a spatial area with three rooms separated by walls 102 and 104 and a transmitter 106 located in the upper-left hand corner of the spatial area. However, it should be recognized that a spatial area for which the measurement map 100 can be generated may include any number of contiguous or non-contiguous boundaries (e.g., walls) and any number of transmitters. Within the measurement map 100, signal measurements are strongest in areas that are close to the transmitter 106, as illustrated by the regions of layout having lower luminance values (or darker colors, if in color), and that signal measurements generally become weaker as a function of distance from the transmitter 106, as illustrated by regions having higher luminance values (or lighter colors, if in color). This observation generally comports with the properties of radio communications, in which the received power of a signal decreases as a function of increasing distance from a transmitting device, assuming a clear line-of-sight between a receiving device and the transmitting device.

Further, it may be seen that the walls 102 and 104 may affect the signal measurements captured in different portions of the spatial area represented by the measurement map 100. For example, signal measurements in a first room 107 may be weaker than measurements at the far end (relative to the transmitter 106) of a second room 109 due to signal attenuation caused by the wall 102, even though the distance between any point in the first room 107 and the transmitter 106 may be shorter than the distance between a point at the right side of the second room 109 and the transmitter 106. Similarly, signal measurements in a third room 108 may be weaker than measurements at either the first room 107 or the second room 109 due to signal attenuation caused by the walls 102 and 104 and distance from the transmitter 106. Thus, based on an assumption that a single transmitter 106 exists in the spatial area, the layout of the spatial area can be inferred by examining signal measurements captured within the entirety of a spatial area represented by the measurement map 100 and identifying points in the spatial area at which signal measurements change significantly relative to an origin point associated with this single transmitter 106. The point at which signal measurements change significantly may be indicative of a wall or other boundary separating different portions of the spatial area, while gradual changes in signal measurements may be indicative of increasing distance from the transmitter 106 within the same, unobstructed, portion of the spatial area.

While the radio frequency measurements illustrated in the measurement map 100 generally provide a significant amount of information about the layout of a spatial area from which the measurement map 100 was generated, it may be impractical to obtain a measurement at each location within the spatial area. Rather, a device may generate a measurement map 110 with measurements obtained along a path 112 traversed through the spatial area. As illustrated, the measurements obtained along the path 112 in the measurement map 110 may be a sparse subset of the possible measurements that could be obtained within the spatial area, as illustrated by the measurement map 100. However, the measurements obtained along the path 112 may include additional information that defines how the path 112 was generated. For example, because a device cannot be located in multiple places at the same time, each measurement may be associated with a timestamp indicating when the measurement was obtained. Because each measurement may be associated with a timestamp, the measurements generated along the path 112 may be organized into an ordered set in which the first element in the ordered set corresponds to the earliest measurement (e.g., a measurement at time 0) and the last measurement in the ordered set corresponds to the latest measurement obtained while traversing the path 112. Further, information about the direction of travel, speed, acceleration, and other movement information can be derived from the timing information associated with each measurement captured while traversing the path 112 and/or from one or more sensors at a device that generated these measurements.

It should be noted that the measurements obtained while traversing the path 112 may not include actual position information associated with each measurement. For example, in a building, it may be difficult to obtain precise data from a satellite positioning system (e.g., GPS, GLONASS, GALILEO, etc.) due to an inability to obtain signaling from a sufficient number of satellites. In another example, a mobile device that is gathering these measurements may not have access to external visual data that may aid in locating the user within a spatial area. Thus, the path 112 may represent a traversal through an undefined spatial area defined in terms of timestamps and directional acceleration and velocity information from which a layout of the spatial area can be inferred.

To generate an input data set that can be used to train a machine learning model to predict the layout of a spatial area, as discussed in further detail below, measurements obtained while traversing the path 112 can be transformed into a set of multidimensional samples, with each multidimensional sample in the set representing a discrete measurement obtained while traversing the path 112. To allow for the set of multidimensional samples to represent the measurements obtained while traversing the path 112 and retain information about the order in which these measurements were obtained, a multidimensional sample may thus include information about the measurement, as well as other contextual information associated with the measurement.

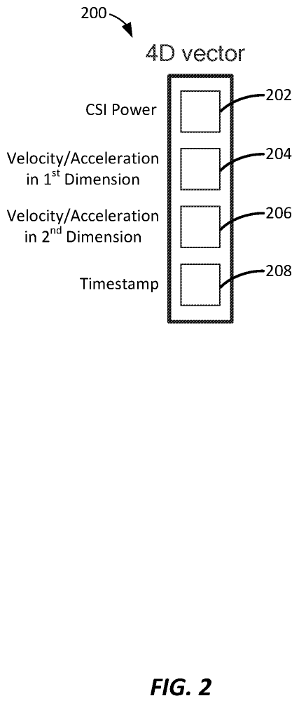

FIG. 2 illustrates an example multidimensional sample 200 representing a measurement obtained at a point along a path in a spatial area, according to aspects of the present disclosure. As illustrated, the multidimensional sample 200 may be a four-dimensional multidimensional sample (e.g., a 4×1 vector) with elements 202, 204, 206, and 208. The element 202 may include the signal measurement obtained at a particular point in the spatial area. This signal measurement may include, for example, a measured signal strength (e.g., in decibels or decibel-milliwatts) a signal-to-noise ratio (SNR), a signal-to-interference-plus-noise ratio (SINR), or other measurements that indicate the strength or quality of a signal obtained at a point along the path in the spatial area. The element 208 may be associated with a timestamp associated with the measurement in the element 202.

The elements 204 and 206, meanwhile, may provide additional contextual information about the motion of the device. For example, the elements 204 and 206 may include two-dimensional velocity and acceleration information. This directional velocity and acceleration information may, for example, be represented by velocity and acceleration information on a first axis (dimension) in the element 204 and velocity and acceleration information on a second axis (dimension) in the element 206. In another example, though not illustrated, the element 204 may include two-dimensional velocity information, and the element 206 may include two-dimensional acceleration information. By including two-dimensional velocity and acceleration information in multidimensional sample 200, the set of multidimensional samples may be used to predict the two-dimensional layout of a spatial area, as discussed in further detail below. Generally, the velocity and acceleration information may be obtained from various sensors on a device, such as accelerometers, gyroscopes, or other motion sensing devices integral with or connected to a device that obtains measurements while traversing a path through a spatial area.

Example Set Predictor Models for Predicting the Layout of a Spatial Area Based on Multidimensional Samples from the Spatial Area

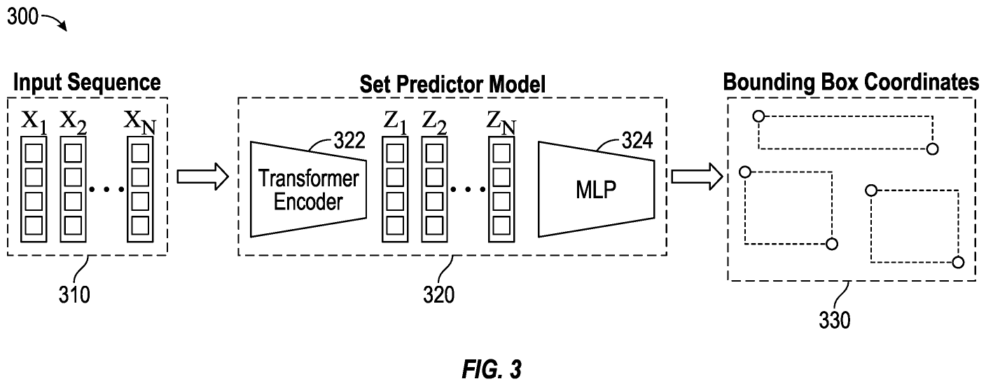

To predict the layout of a spatial area, aspects of the present disclosure use a set of multidimensional data representations (e.g., vectors) representing measurements obtained along a path traversed through a spatial area as an input into a set predictor model which predicts the members of a set of bounding boxes representing a spatial area based on the set of multidimensional data representations. The set predictor model may be trained (as discussed in further detail herein with respect to FIGS. 3 through 5) to predict the shapes of bounding boxes (or other bounding polygons or ellipses) defining different portions of a spatial area and may generate the predicted layout of the spatial area by matching the points defining these bounding boxes.

FIG. 3 illustrates an example pipeline 300 for predicting a layout of a spatial area based on a set of multidimensional samples representing data captured while traversing a path through a spatial area and a set predictor model, according to aspects of the present disclosure.

Generally, N measurements may be obtained by traversing a path through a spatial area (e.g., the path 112 illustrated in FIG. 1). Each measurement may be associated with a specific location in the spatial area and a specific timestamp at which the measurement was taken. From the N measurements, an input sequence 310 may be generated as a set of N multidimensional samples {x₁, x₂, . . . , x_{N}}, with each sample x being formatted as discussed above with respect to FIG. 2 in some aspects. The input sequence 310 may be provided as input into a set predictor model 320, and the set predictor model may generate a series of bounding box coordinates 330 (or coordinates for another bounding shape). The bounding box coordinates 330 may include coordinates for each of a plurality of rooms in a spatial area, for example.

As illustrated, the set predictor model 320 includes a first machine learning model 322 and a second machine learning model 324. The first machine learning model 322 generally is trained to map the input sequence 310 into a representation of the input sequence {z₁, z₂, . . . , z_{N}}. The second machine learning model 324 is trained to use the representation of the input sequence {z₁, z₂, . . . , z_{N}} as an input to generate the coordinates of the bounding boxes representing different definable spaces (e.g., rooms) in the spatial area. In some aspects, the first machine learning model 322 may be a transformer encoder machine learning model that encodes the input sequence 310 into a representation of the input sequence, and the second machine learning model 324 may be a multilayer perceptron (MLP) or other neural network that generates the coordinates of the bounding boxes based on the representation of the input sequence generated by the transformer encoder machine learning model.

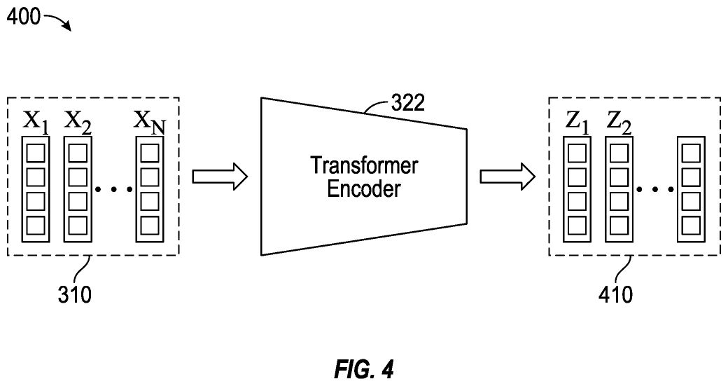

FIG. 4 illustrates an example 400 of generating, using the first machine learning model 322, a representation for each sample in a set of multidimensional samples representing data captured while traversing a path through a spatial area, according to aspects of the present disclosure. As discussed, the first machine learning model 322 may be a transformer encoder model that encodes the input sequence 310 of multidimensional samples representing measurements in a spatial area into an output sequence 410 of the input sequence 310. Generally, the input sequence 310 and the output sequence 410 may include N samples, with each sample in the input sequence 310 of multidimensional samples being mapped to a respective representation in the output sequence 410. That is, the dimensionality and length of the input sequence 310 may be the same as the dimensionality and length of the output sequence 410.

The first machine learning model 322 may be a transformer encoder that is structured as a neural network trained to encode samples in the input sequence 310 to representations, such as a latent space representation, based on correlations between sequences of samples in the input sequence 310. For example, a transformer encoder may include one or more self-attention layers that process different sequences from the set of input sequences and a feed-forward network that applies linear transformations to the input sequence using different parameters in order to encode each multidimensional sample in the input sequence 310 into a respective representation in the output sequence 410, which may be fed as an input into the second machine learning model 324 to generate the bounding boxes (e.g., the bounding box coordinates 330) defining discrete portions of a spatial area and the layout of the spatial area from these bounding boxes.

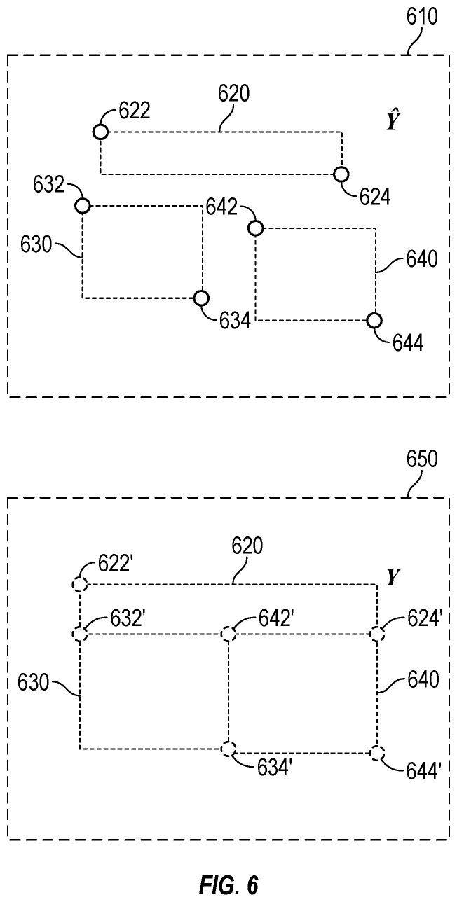

To train the first machine learning model 322, supervised learning techniques may be used. A training data set used to train the first machine learning model 322 may include a set of multidimensional samples representing measurements obtained while traversing a path in a spatial area (e.g., path 112 illustrated in FIG. 1), labeled with coordinates defining each of a plurality of bounding boxes for the spatial area. For example, as illustrated in FIG. 6 and described in further detail below, the bounding boxes may be defined in terms of coordinates of opposing corners of a box (e.g., the upper-left corner and the lower-right corner). In some aspects, where rooms can have a non-rectangular shape, the bounding boxes may be defined in terms of coordinates of each vertex in the room such that an n-sided polygon is defined in terms of n coordinates.

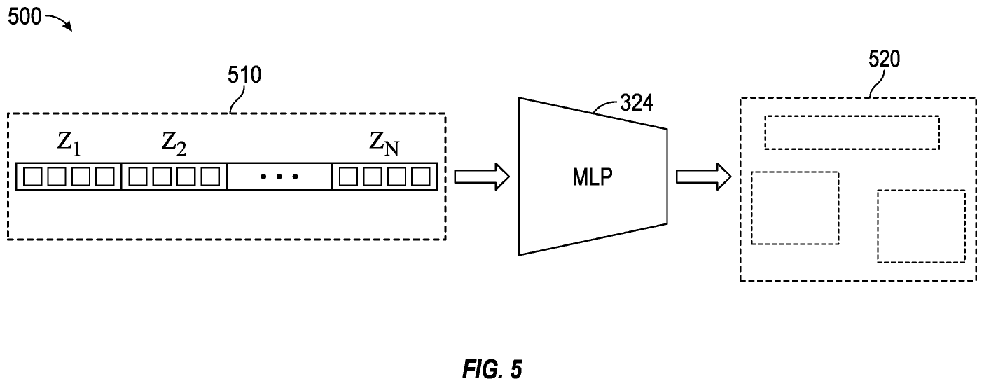

FIG. 5 illustrates an example 500 of generating bounding boxes from representations of multidimensional samples representing data captured while traversing a path through a spatial area using the second machine learning model 324, according to aspects of the present disclosure. As illustrated, the representations of each sample of the plurality of multidimensional samples in an input data set (e.g., the output sequence 410 illustrated in FIG. 4) may be flattened into a vector 510. This vector 510 may have dimensions of 1 by (n*4), and each discrete group of four elements representing a specific sample of the plurality of multidimensional samples, assuming that each sample of the plurality of multidimensional samples has four dimensions (it should be recognized, however, that a multidimensional sample may include fewer dimensions or greater dimensions, and the use of a four-dimensional sample is merely illustrative). That is, elements (i−1)*4 through (i−1)*4+3, i∈{1, . . . , n} may be associated with the i^{th} sample of the plurality of multidimensional samples in the input sequence 310. The vector 510 may be input into the second machine learning model 324, which generates a set of bounding boxes 520 representing the different discrete portions (e.g., rooms) in the spatial area.

As discussed, the second machine learning model 324 may be a multilayer perceptron in some aspects, which is generally a neural network with a number of layers that aggregates information globally and maps the representations of the multidimensional samples to the coordinates of bounding boxes in a metric space. The second machine learning model 324 may be trained to generate the bounding boxes and the layout of these bounding boxes, by matching point sets corresponding to the coordinates of the bounding boxes representing different discrete areas of the spatial area.

In some aspects, the second machine learning model may be trained to match point sets corresponding to coordinates of the bounding boxes based on a minimization of a Chamfer distance (serving as a loss function to be minimized) between coordinates of the bounding boxes in order to generate the layout of the spatial area. Generally, this Chamfer distance may be an evaluation metric that evaluates the distance between points in different point clouds (in this example, the distance between the coordinates of the bounding boxes in the set of bounding boxes 520 and the coordinates of the bounding boxes in a candidate layout of the spatial area). Given a set of bounding boxes 520 represented as Ŷ and a desired layout of the spatial area represented by Y, the Chamfer distance may be represented by the equation:

$$L ( \hat{Y} , Y ) = {\sum }_{i} {min}_{j} {‖ \hat{{y}_{ι}} - {y}_{j} ‖}^{2} + {\sum }_{j} {min}_{i} {‖ \hat{{y}_{ι}} - {y}_{j} ‖}^{2}$$

where ŷ_{ι} represents a coordinate of the i^{th} sample in the set of bounding boxes Ŷ 520 and yⱼ represents a coordinate of the j^{th} sample in a layout Y generated by matching the point sets of the bounding boxes in the set of bounding boxes 520. In some aspects, the second model may further be trained to minimize a mean intersection over union (IoU) measurement between the bounding boxes. Generally, a mean IoU measurement may represent the ratio of the area of the boxes over which two bounding boxes intersect (e.g., the area over which the two bounding boxes overlap) to the area of the union of the two bounding boxes (e.g., the total area encompassed by the two bounding boxes). Generally, an IoU measurement approaching 1 may indicate a large amount of overlap between two bounding boxes, while an IoU measurement approaching 0 may indicate a small amount of overlap between two bounding boxes. Because two discrete areas of a spatial area (e.g., two rooms in a building) cannot overlap with each other, minimizing a mean IoU measurement may allow the second machine learning model to predict a layout of the spatial area that constitutes a valid layout of the spatial area.

In some aspects, the second machine learning model may be trained to match point sets corresponding to coordinates of the bounding boxes based on a minimization of a Hungarian loss metric corresponding to coordinates of each bounding box of the plurality of bounding boxes. Generally, the Hungarian loss metric defines the magnitude of a match between different pairs of points (in this example, between the coordinates of the bounding boxes in the set of bounding boxes Ŷ 520) such that the second machine learning model 324 optimizes the assignment of inferred bounding box coordinates to ground truth bounding box coordinates. The second machine learning model 324 may further be trained to minimize a mean IoU measurement between the bounding boxes.

FIG. 6 illustrates a transformation of bounding boxes representing different portions of a spatial area into a layout of the spatial area, according to aspects of the present disclosure. As discussed, the second machine learning model 324 illustrated in FIG. 3 generates a set of bounding boxes 610 including the bounding boxes 620, 630, and 640. The bounding box 620 is defined in relation to points 622 and 624, representing opposite corners of the bounding box 620. Likewise, the bounding box 630 is defined in relation to points 632 and 634, and the bounding box 640 is defined in relation to points 642 and 644.

Based on the techniques discussed above (e.g., minimization of Chamfer distance, minimization of Hungarian loss, minimization of mean IoU, etc.), the set predictor model 320 illustrated in FIG. 3 generates a layout 650 by matching point sets for the bounding boxes 620, 630, and 640. In this example, the points defining the bounding box 620 may be translated to points 622′ and 624′ in a two-dimensional space. Meanwhile, the bounding box 630 may be defined in terms of translated points 632′ and 634′, with the point 632′ being positioned such that the upper-left corner of the bounding box 630 is matched to the lower-left corner of the bounding box 620. Finally, the bounding box 640 may be defined in terms of translated points 642′ and 644′. In moving the bounding box 640 to its position in the layout 650, the upper-right corner of the bounding box 640 is matched to the point 624′ defining the lower-right corner of the bounding box 620, the upper-left corner of the bounding box 640 defined by the point 642′ is matched to the upper-right corner of the bounding box 630, and the lower-left corner of the bounding box 640 is matched to the lower-right corner of the bounding box 630 defined by the point 634′.

In some aspects, a set of multidimensional samples captured by traversing a path in a spatial area may be associated with any one of a plurality of candidate layouts with different sizes of bounding boxes and different layouts of these bounding boxes. Because a set of multidimensional samples may be associated with any one of a plurality of candidate layouts, the set predictor model may be trained as a probabilistic model in which layouts are predicted based on a predicted distribution of layouts in the spatial area for any given input data set. In such a case, the set predictor model can predict the layout of the spatial area in which a set of multidimensional samples are captured based on a joint distribution over the parameters of the set predictor model and the distribution of layouts.

A joint distribution may be defined according to the equation:

$$p ( w , D ) = p ( D \vert w ) p ( w )$$

where w represents the model parameters, D represents a distribution over a universe of layouts, p represents a probability, and p(D|w) represents a probability distribution conditioned on a specific set of model parameters. The posterior distribution over the weights of the set predictor model may be represented by the equation:

$$p ( w \vert D ) = \frac{p ( D \vert w ) p ( w )}{\int p ( D \vert w ) p ( w ) d w} = \frac{p ( D \vert w ) p ( w )}{p ( D )}$$

The posterior term, ∫f(w)p(w|D)dw may be used to predict which layout of a plurality of layouts is the likely layout for a given input of multidimensional samples captured by traversing a path through an unknown spatial area. However, because finding the true posterior p(w|D) is an intractable problem, an approximate probability distribution q_{θ}(w) may be defined, and the posterior distribution may be optimized based on a Kullback-Leibler (KL) divergence measurement of the approximate probability distribution q_{θ}(w). In predicting the posterior distribution, a KL divergence measurement may be defined according to the equations:

$$KL [ {q}_{θ} ( w ) ‖ p ( w \vert D ) ] = \int {q}_{θ} ( w ) log \frac{{q}_{θ} ( w )}{p ( w \vert D )} dw \\ and$$

$$KL [ {q}_{θ} ( w ) ‖ p ( w \vert D ) ] = {𝔼}_{q} [ log \frac{{q}_{θ} ( w )}{p ( w )} - log p ( D \vert w ) ] + log p ( D )$$

Thus, the KL divergence measurement may be represented according to the equation:

$$KL [ {q}_{θ} ( w ) ‖ p ( w \vert D ) ] = KL [ {q}_{θ} ( w ) ‖ p ( w ) ] - {𝔼}_{q} [ log p ( D \vert w ) ] + log p ( D )$$

The resulting probability distribution may be made a “peaky” distribution to reduce the level of uncertainty in the prediction of the layout of the spatial area generated by the set predictor model. In some cases, where there is some uncertainty about the appropriate layout for a given path through the spatial area as an input, the resulting probability distribution may be flat or have multiple peaks.

It should be noted that many spatial areas may be laid out with openings in walls that may affect the signal measurements obtained within these spatial areas. For example, while a wall may attenuate a signal, an opening such as a door may provide a clear line of sight for a transmitter to transmit signaling to a receiving device. The set predictor model discussed herein may be trained with data from these environments to predict the layout of such a spatial area, including the openings between different bounding boxes representing doors or other breaks in barriers between discrete portions of a spatial area. To recognize openings in these spatial areas, the machine learning models may be trained using a training data set that includes both points representing vertices of a bounding box defining a room and locations of openings between different discrete portions of the spatial area. Because these openings may not attenuate a signal in the way that a wall or other barrier would attenuate a signal, the model can identify these openings based, at least in part, on identifying a local spike in signal measurements (e.g., a local spike in received power, SNR, SINR, etc.) that is bounded by signal measurements indicating a degraded signal quality (e.g., a decrease in received power, SNR, SINR, etc.) relative to the measurements associated with this local spike.

Example Transformer Models Predicting the Layout of a Spatial Area Based on Signal Measurement Samples from the Spatial Area

Generally, a spatial area may include multiple discrete portions (e.g., rooms) and passages (e.g., doors) between different portions of the spatial area. To predict the layout of the spatial area, including these passages between different portions of the spatial area, aspects of the present disclosure can use signal measurements, such as channel state information (CSI) measurements and time data derived therefrom as inputs into a machine learning model that is trained to generate a predicted layout of the spatial area.

Channel state information data may be a complex input including multiple components, such as the sine of phase, cosine of phase, and magnitude components. For a wireless device with four antennas measuring 64 complex subtones from a received signal, each channel state information sample (which includes the aforementioned phase and magnitude components for each antenna and each subtone) may thus result in a 4×64×3 tensor. While channel state information may generally have a timestamp assigned to it based on a time at which the signals on which the channel state information was generated was received, a mapping from data in the frequency domain to the time domain may include multiple peaks corresponding to the different times of arrival of different multipath components caused by reflection, diffraction, and the like. However, due to bandwidth restrictions and compute capabilities available on hardware, these peaks may be smeared and shifted such that some peaks (corresponding to the time of arrival of some multipath components) are merged with other, more dominant peaks. For example, a signal based on which a channel state information sample is generated may include a line-of-sight component that arrives from the transmitter at a time defined by the line-of-sight distance between the transmitter and the wireless device and the speed of light. However, non-line-of-sight components may randomly shift the time of arrival associated with the signal based on which the channel state information sample is generated; thus, time-of-arrival data may not provide reliable, accurate data which can be used by a machine learning model to predict the layout of the spatial area in which a wireless device operates.

Time difference of arrival (TDoA) data, however, can provide useful information about signals that have arrived at a wireless device, or about the same signal arriving at different antennas at the wireless device. However, because the number of arriving signals can differ between different antennas and because it may be impractical to identify whether a signal is a line-of-sight signal or a multipath component, aspects of the present disclosure derive TDoA data from channel state information samples by computing a set of possible time differences between different multipath components or by using pseudo-TDoA data derived from channel state information samples by computing a set of possible products between different multipath components.

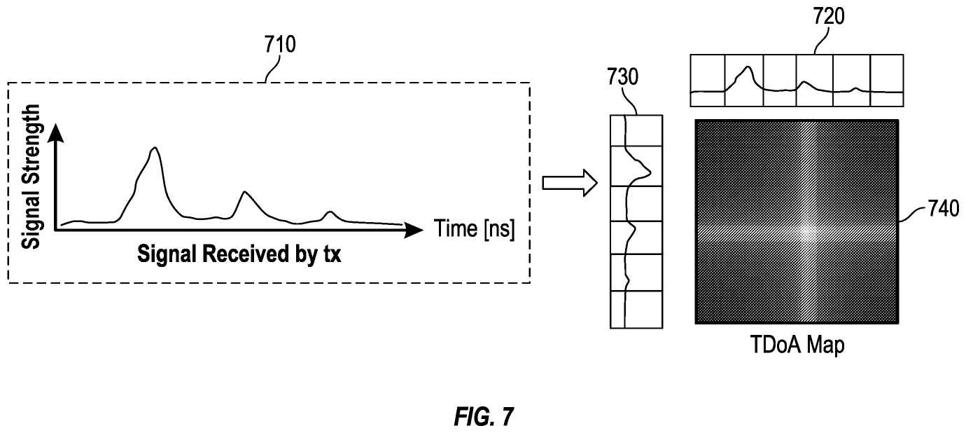

FIG. 7 illustrates generation of an example visual representation of time data used in predicting a layout of a spatial area, according to aspects of the present disclosure.

To generate a visual representation 740 of TDoA data for a received signal, which may be a visual map or other graphical data representing correlations between a received signal at different antennas of a wireless device, a signal 710 may be transformed into time delay information 720 and 730 based on an inverse Fourier transformation of the signal 710. Generally, signal 710 may be represented by measured signal strength over a window of time, and the time delay information 720 and 730 may be generated as matrices including a plurality of time bins (e.g., a number of bins represented by num_bins). In one example, the time delay information 720 may be the result of applying an inverse Fourier transform to the signal 710, and the time delay information 730 may be the result of transposing the time delay information 720 (e.g., rotating the time delay information 720 by 90 degrees, such that a matrix with dimensions of 1×num_bins is transformed into a matrix with dimensions of num_bins×1).

The visual representation 740 of the TDoA data for the received signal may be generated based on a per-bin combination of the time delay information 720 and the time delay information 730. For example, the visual representation 740 of the TDoA data may be generated by subtracting the time delay information 730 from the time delay information 720 for each bin in the matrices representing the time delay information 720 and the time delay information 730. As illustrated, the resulting visual representation 740 of the TDoA information may be an image structured as a two-dimensional matrix with dimensions of num_bins×num_bins and include information identifying timing correlations between signals received by different antennas at the wireless device. The visual representation 740 may, in some aspects, include a set of values, represented by a high luminance value or a bright color, indicating the likely pseudo-TDoA value for signals received by different antennas at the wireless device.

To generate TDoA data which can be used by a machine learning model to predict the layout of a spatial area, as discussed in further detail herein, TDoA data may be generated as discrete visual representations for each antenna in a wireless device. As a result, for a device with n antennas, the visual representations of TDoA information may be a stack of n visual representations of TDoA information, with each individual visual representation being associated with a particular one of the n antennas in the wireless device.

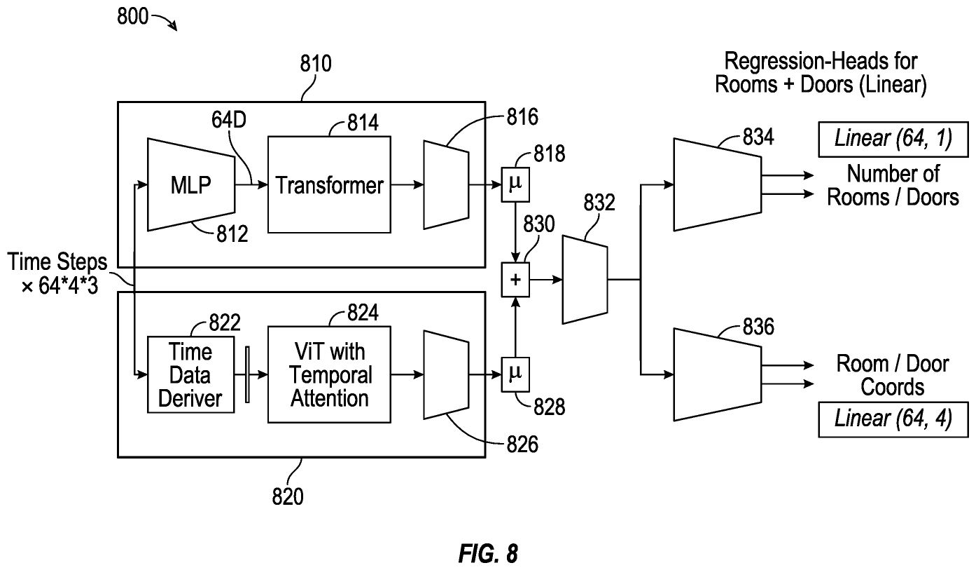

FIG. 8 depicts an example of a machine learning model 800 that predicts a layout of a spatial area based on channel state information and a visual representation of time data, according to aspects of the present disclosure.

As illustrated, the machine learning model 800 includes a channel state information branch 810 and a temporal information branch 820. The channel state information branch 810 of the machine learning model 800, as illustrated, includes a multilayer perceptron 812, a transformer neural network 814, and an activation function 816 that generates an intermediate output from the channel state information received as input into the machine learning model 800. The multilayer perceptron 812 generally transforms the channel state information input into the machine learning model 800 into a representation in a different dimension. For example, a channel state information sample over 64 subtones using a number of antennas a and a number of components c (e.g., 4 antennas and 3 components, as discussed above) may be transformed into a 64-dimensional sample which may be provided as input into a transformer neural network 814.

The transformer neural network 814 may include a plurality of layers and include an activation function, such as a rectified linear unit (ReLU), Gaussian error linear unit (GELU), continuously differential exponential unit (CELU), or the like, to generate a representation of the input channel state information. This generated representation may be fed as input into an activation function 816, which generates a post-activation representation for each sample of the channel state information input into the machine learning model 800.

Meanwhile, the temporal information branch 820 uses the received channel state information to generate an attention output from time data derived from the channel state information. As illustrated, temporal information branch 820 includes a time data deriver 822, a vision transformer neural network 824, and an activation function 826. Generation of the attention output through the vision transformer neural network 824 and activation function 826 may be performed using one or more instances of the vision transformer neural network 824 and activation function 826. To generate this attention output, time data deriver 822 may first generate a plurality of visual representations of time information (e.g., images representing TDoA relationships between different signals) from the channel state information received as input into the machine learning model 800. As discussed, to generate these visual representations of time information from the channel state information, channel state information samples represented as received signal strength over a period of time may be transformed into one-dimensional timing information matrices using an inverse Fourier transform. A generated one-dimensional timing information matrix may be transposed to generate a second timing information matrix, and the generated one-dimensional timing information matrix and the second timing information matrix may be combined in order to generate a two-dimensional visual representation of time data (e.g., TDoA data) for an antenna of a wireless device. Generally, time data deriver 822 may generate a visual representation of time data for each antenna, and thus generate a stack of a visual representations of time data for a wireless device with a antennas.

A sequence of channel state information data provided as input to machine learning model 800 may thus be represented as a sequence of visual representations of time data for the wireless device. This sequence may be input into the vision transformer neural network 824, which may include temporal attention blocks that are trained to recognize temporal relationships between different components, to generate an output. The attention output generated by the vision transformer neural network 824 may subsequently be fed as input into an activation function 826, which generates an attention output from the time data derived from the channel state information data. The activation function 826, like the activation function 816, may be a Gaussian error linear unit which implements a function that multiplies the input by the cumulative density function of the normal distribution at the input.

Post-activation representations of the channel state information input into the machine learning model 800 generated by the channel state information branch 810 may be averaged at channel state information averaging block 818. The attention output generated by the temporal information branch 820 may be averaged at temporal information averaging block 828 or may be generated based on an input sequence including a special token. The averaged post-activation representations of the channel state information or the output of the channel state information branch 818 based on a combination of the sequence of channel state information and a special vector, and the averaged attention output for the channel state information, may be combined at combiner block 830 and further processed using a global activation layer 832 to generate a post-activation combined representation of the channel state information and time data derived from the channel state information.

The post-activation combined representation may be provided as input into a first regression head 834 that predicts a number of rooms and openings between rooms in the spatial area and a second regression head 836 that predicts the coordinates of the rooms and openings between rooms in the spatial area. The first regression head 834 may be a linear unit trained to generate one-dimensional scalar data from a higher-dimensional post-activation combined representation. The second regression head 836 may also be a linear unit; however, to identify the coordinates of rooms and openings between rooms, the second regression head 836 may generate a plurality of coordinate outputs defining the locations of rooms and the openings between rooms. For example, as discussed above, a room may be defined as a set of points, such as opposite corner points (e.g., top-left and bottom-right points) on a two-dimensional plane for a regular four-sided room (e.g., a room shaped as a rectangle). Similarly, the location of an opening from one room to another room may be defined as a pair of points in a two-dimensional plane. The pair of points may generally be located on, or at least proximate to, a polygon or other shape representing the boundaries of a room.

In some aspects, the predicted layout of the spatial area, defined by the outputs of the first regression head 834 and the second regression head 836, may be further refined in post-processing operations on the outputs. For example, these post-processing outputs may refine the predicted layout of the spatial area by minimizing (or at least reducing) free space in a predicted layout, minimizing (or at least reducing) overlap between rooms, moving openings to borders of rooms, and the like.

Example Operations for Predicting the Layout of a Spatial Area Based on Samples from the Spatial Area

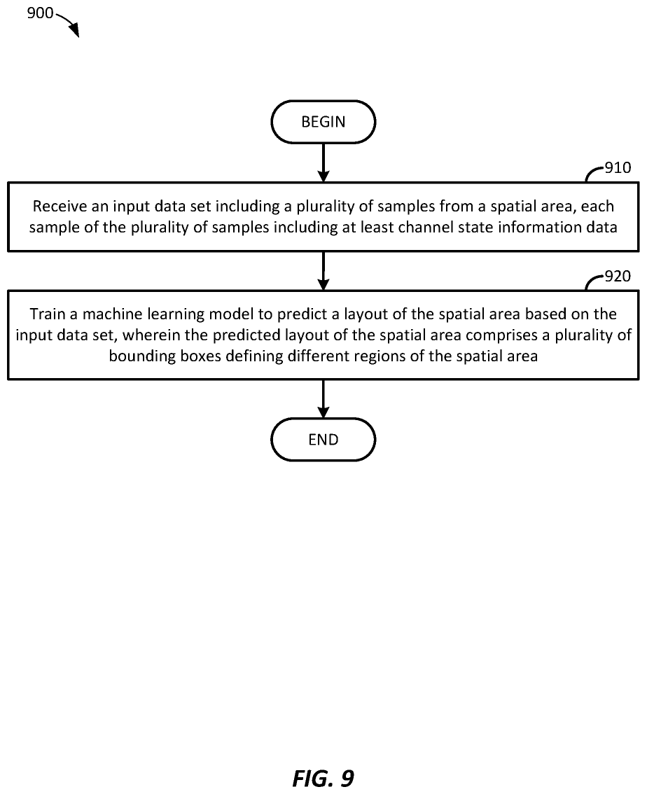

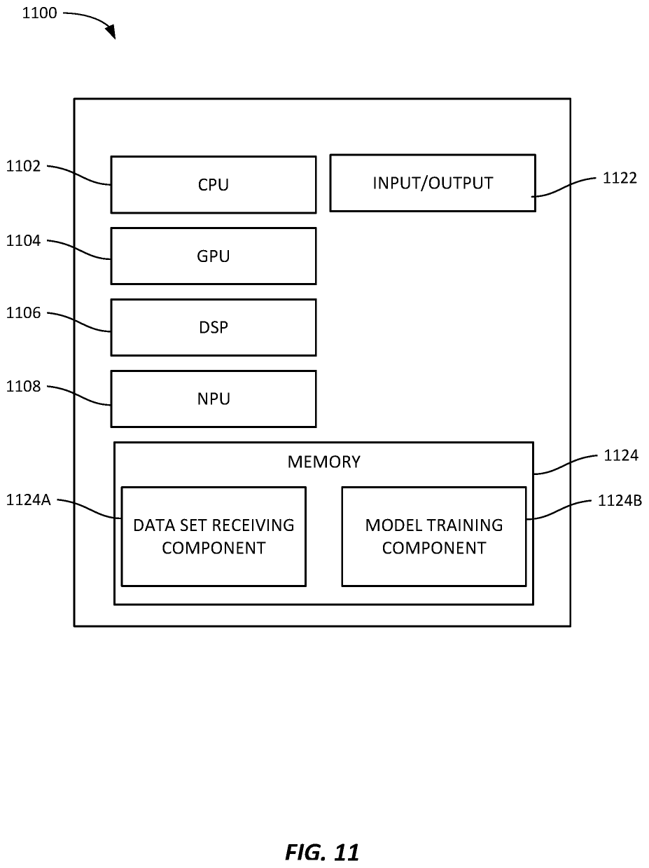

FIG. 9 illustrates example operations 900 that may be performed by a computing device (e.g., system 1100 illustrated in FIG. 11) to train a machine learning model to predict a layout of a spatial area based on an input data set of samples from the spatial area. The computing device may be, for example, a server, a cluster of servers, or other computing device that can use sets of samples and layouts of spatial areas in which these samples are captured to train a machine learning model to predict the layout of a spatial area.

As illustrated, the operations 900 begin at block 910 with receiving an input data set. Generally, the input data set includes a plurality of samples from a spatial area. Each sample may include at least channel state information data. In some aspects, the sample may further include localization data and time data. In some aspects, the channel state information data may include power measurements, such as a measured signal strength (e.g., in decibels or decibel-milliwatts), a calculated SNR, a calculated SINR, or the like at a given location and time in a three-dimensional space. In some aspects, the localization data may include acceleration data and velocity data produced by one or more motion sensors on a device that captures the power measurements, such as accelerometers, gyroscopes, compasses, or other motion or position sensors integral to or coupled with the device. The acceleration data and velocity data may include directional acceleration and velocity for each of a plurality of dimensions. For example, in a two-dimensional mapping scenario, the acceleration and velocity data may include acceleration and velocity data for the forward-backward axis and for the lateral (side-to-side) axis. In a three-dimensional mapping scenario, however, the acceleration and velocity data may include acceleration and velocity data for the forward-backward axis, the lateral axis, and the vertical axis.

At block 920, operations 900 proceed with training a machine learning model to predict a layout of the spatial area based on the input data set. Generally, the predicted layout of the spatial area includes a plurality of bounding boxes defining different regions of the spatial area.

In some aspects, training the machine learning model includes training a first machine learning model (e.g., the channel state information branch 810 illustrated in FIG. 8) that generates an intermediate output from the channel state information data and training a second machine learning model (e.g., the temporal information branch 820 illustrated in FIG. 8) that generates an attention output from time data derived from the channel state information data.

In some aspects, training the machine learning model may further include training the machine learning model to generate a post-activation combined average based on applying an activation function to a combination of a time-averaged output of the first model and a time-averaged output of the second model.

In some aspects, training the machine learning model may further include training the machine learning model to output information defining the predicted layout of the spatial area based on a plurality of regression heads and the post-activation combined average.

In some aspects, the time data derived from the channel state information may be visual representations of TDoA information for each antenna of a plurality of antennas of a wireless device associated with the channel state information data for each channel state information sample in the input data set. The first machine learning model may be a transformer neural network, and the second machine learning model may include any number of instances of a vision transformer and multi-head attention block that generates the attention output from time data based on the visual representations of TDoA information for each antenna of the plurality of antennas. In some aspects, the visual representations of TDoA information for each antenna of the plurality of antennas may be generated based on an inverse Fourier transform of the channel state information data and a transposed version of the inverse Fourier transform of the channel state information data.

In some aspects, the predicted layout of the spatial area further comprises one or more of a predicted number of regions in the spatial area, a predicted number of openings between regions in the spatial area, predicted coordinates of each region in the spatial area, and predicted coordinates of each opening between regions in the spatial area.

In some aspects, the plurality of samples may include multidimensional samples including the channel state information data, localization data, and time data for each sample in the input data set. Training the machine learning model may generally include training a set predictor model including a first machine learning model and a second machine learning model. The first machine learning model (e.g., the first machine learning model 322 illustrated in FIG. 3) may be trained to generate a representation of each sample of the plurality of multidimensional samples (e.g., the output sequence 410 illustrated in FIG. 4, generated based on the input sequence 310 of multidimensional samples illustrated in FIG. 3). The second machine learning model (e.g., the second machine learning model 324 illustrated in FIG. 3) may be trained to generate bounding boxes for discrete portions of the spatial area and the layout of the spatial area based on the representation of each sample of the plurality of multidimensional samples.

In some aspects, the first model may be a transformer encoder. Training the transformer encoder may include training the transformer encoder to generate, from the input data set, an output sequence that identifies local correlations within sequences of samples in the data set.

In some aspects, training the second machine learning model may include training a model to generate the bounding boxes and a layout of the spatial area from the bounding boxes. Each bounding box may generally be defined as a set of coordinates in a multi-dimensional space.

In some aspects, to generate the layout of the spatial area, training the second machine learning model may further include training the second machine learning model to match point sets corresponding to coordinates of the bounding boxes based on a minimization of a Chamfer distance between coordinates of the bounding boxes. The second model may further be trained to minimize a mean intersection over union (IoU) measurement between the bounding boxes. As discussed, by minimizing a mean IoU measurement between bounding boxes, a layout may be generated that recognizes the physical impossibility of two discrete rooms overlapping with each other in a spatial environment.

In some aspects, training the second machine learning model may further comprise training the second machine learning model to match point sets corresponding to coordinates of the bounding boxes based on a minimization of a Hungarian loss metric. The second machine learning model may further be trained to minimize a mean IoU measurement between the bounding boxes.

In some aspects, training the machine learning model includes training the machine learning model to predict the layout of the spatial area based on a predicted distribution of layouts in the spatial area for the input data set. The set predictor model may be trained to predict the distribution of layouts based on a joint distribution over parameters of the set predictor model and the predicted distribution of layouts. In some aspects, the set predictor model may be trained to predict a posterior distribution over weights of the set predictor model. Because calculating a posterior distribution may be an intractable problem, the posterior distribution may be approximated based on a Kullback-Leibler (KL)-divergence measurement of an approximate probability distribution over the weights of the set predictor model.

In some aspects, the machine learning model may be trained to generate bounding boxes to have non-contiguous coordinates. Generally, these non-contiguous coordinates may represent openings between different discrete portions of a spatial area, such as doors between rooms, open passages between rooms, or the like.

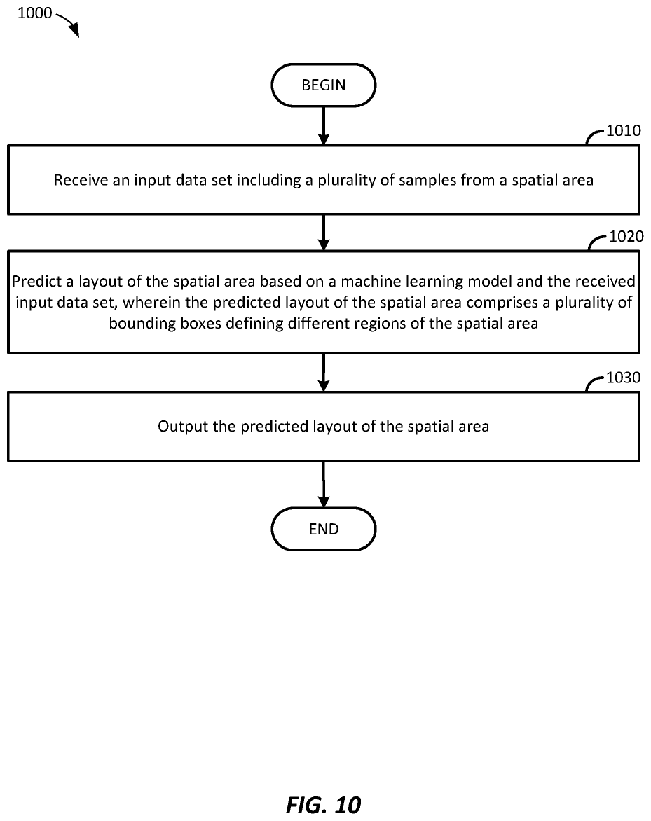

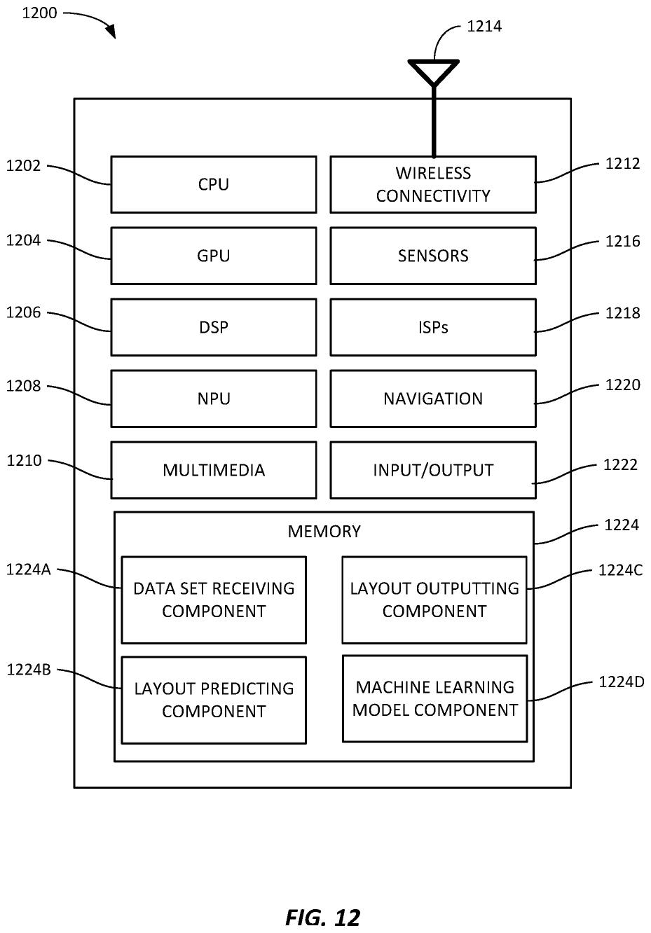

FIG. 10 illustrates example operations 1000 that may be performed by a computing device (e.g., system 1200 illustrated in FIG. 12) to predict a layout of a spatial area based on a machine learning model and an input data set of samples from the spatial area. The computing device may include, for example, a mobile phone, a tablet computer, a laptop computer, or other device that can capture signal measurements from a plurality of locations within a spatial environment and use the signal measurements and motion information to generate multidimensional samples usable by a machine learning model to predict a layout of a spatial area.

As illustrated, the operations 1000 begin at block 1010 with receiving an input data set including a plurality of samples from a spatial area. As discussed, each sample of the plurality of samples from a spatial area generally includes at least channel state information data. In some aspects, each sample may be a multidimensional sample including the channel state information, localization data, and time data. In some aspects, the channel state information data may include power measurements, such as a measured signal strength (e.g., in decibels), a calculated SNR, a calculated SINR, or the like at a given location and time in a three-dimensional space. In some aspects, the localization data may include directional acceleration data and velocity data. The acceleration data and velocity data may include acceleration and velocity for each of a plurality of dimensions. For example, in a two-dimensional mapping scenario, the acceleration and velocity data may include acceleration and velocity data for the forward-backward axis and for the lateral (side-to-side) axis. In a three-dimensional mapping scenario, however, the acceleration and velocity data may include acceleration and velocity data for the forward-backward axis, the lateral axis, and the vertical axis.

Operations 1000 proceed to block 1020 with predicting a layout of the spatial area based on a machine learning model and the received input data set. Generally, the predicted layout of the spatial area includes a plurality of bounding boxes defining different regions of the spatial area.

In some aspects, predicting the layout of the spatial area includes predicting the layout based on an intermediate output generated by a first machine learning model (e.g., channel state information branch 810 illustrated in FIG. 8) from the channel state information data and an attention output generated by a second machine learning model (e.g., temporal information branch 820 illustrated in FIG. 8) from time data derived from the channel state information data.

In some aspects, predicting the layout of the spatial area further comprises generating a post-activation combined average based on an activation function applied to a combination of a time-averaged output of the first model and a time-averaged output of the second model.

In some aspects, predicting the layout of the spatial area further comprises generating, based on a plurality of regression heads and the post-activation combined average, information defining the predicted layout of the spatial area.

In some aspects, the time data comprises visual representations of time difference of arrival (TDoA) information for each antenna of a plurality of antennas of a wireless device associated with the channel state information data for each channel state information sample in the input data set. The first machine learning model may be a transformer neural network, and the second machine learning model may be a vision transformer that generates the attention output from time data based on the visual representations of TDoA information for each antenna of the plurality of antennas. In some aspects, the visual representations of TDoA information for each antenna of the plurality of antennas may be generated based on an inverse Fourier transform of the channel state information data and a transposed version of the inverse Fourier transform of the channel state information data.

In some aspects, the predicted layout of the spatial area further comprises at least one of a predicted number of regions in the spatial area, a predicted number of openings between regions in the spatial area, predicted coordinates of each region in the spatial area, and predicted coordinates of each opening between regions in the spatial area

In some aspects, predicting the layout of the spatial area comprises generating a representation of each sample of the plurality of samples (e.g., output sequence 410 illustrated in FIG. 4, generated based on an input sequence 310 of multidimensional samples illustrated in FIG. 3) using a first machine learning model (e.g., first machine learning model 322 illustrated in FIG. 3) trained to generate a representation of each sample of the plurality of multidimensional samples. Bounding boxes for discrete portions of the spatial area and the layout of the spatial area may be generated using a second machine learning model (e.g., second machine learning model 324 illustrated in FIG. 3).

In some aspects, the first machine learning model may be a transformer encoder. The transformer encoder may be configured to generate, from the input data set, an output sequence with same dimensions as the input data set. This output sequence generally identifies local correlations within sequences of samples in the input data set.

In some aspects, the second machine learning model may be a model configured to generate the bounding boxes and a layout of the spatial area from the bounding boxes. Each bounding box may be defined in terms of a set of coordinates in a multi-dimensional space.

In some aspects, to generate the layout of the spatial area, the second machine learning model may match point sets corresponding to coordinates of the bounding boxes based on a minimization of a Chamfer distance between coordinates of the bounding boxes. The second machine learning model may further minimize a mean IoU measurement between the bounding boxes. As discussed, by minimizing a mean IoU measurement between bounding boxes, a layout may be generated that recognizes the physical impossibility of two discrete rooms overlapping with each other in a spatial environment.

In some aspects, to generate the layout of the spatial area, the second machine learning model may match point sets corresponding to coordinates of the bounding boxes based on a minimization of a Hungarian loss metric. The second model may further be trained to minimize a mean IoU measurement between the bounding boxes.

In some aspects, the second machine learning model is configured to generate the bounding boxes by mapping a representation of each sample of the plurality of multidimensional samples generated by the first machine learning model to coordinates of the bounding boxes.

In some aspects, predicting the layout of the spatial area includes predicting the layout of the spatial area over a plurality of possible layouts for the input data set (e.g., based on a probability distribution over the plurality of possible layouts). As discussed, because a set of multidimensional samples captured by traversing a path through a spatial area may be plausibly associated with a number of different layouts of the spatial area, a probability distribution over the plurality of possible layouts may be used to identify the layout with the highest probability of being associated with the input data set including the plurality of multidimensional samples.

In some aspects, the predicted layout may include a plurality of bounding boxes. At least one bounding box of the plurality of bounding boxes may include non-contiguous coordinates. These non-contiguous coordinates may represent, for example, doors, windows, or other openings between different discrete portions of the spatial area.

Operations 1000 proceed to block 1030, with outputting the predicted layout of the spatial area, such as layout 650 depicted in FIG. 6.

Example Processing Systems for Predicting the Layout of a Spatial Area Based on Samples from the Spatial Area

FIG. 11 depicts an example processing system 1100 for training a machine learning models to predict the layout of a spatial area based on samples from the spatial area, such as described herein for example with respect to FIG. 9.

The processing system 1100 includes a central processing unit (CPU) 1102, which in some examples may be a multi-core CPU. Instructions executed at the CPU 1102 may be loaded, for example, from a program memory associated with the CPU 1102 or may be loaded from a memory 1124.

The processing system 1100 also includes additional processing components tailored to specific functions, such as a graphics processing unit (GPU) 1104, a digital signal processor (DSP) 1106, a neural processing unit (NPU) 1108, a multimedia processing unit 1110, a wireless connectivity component 1112.

An NPU, such as the NPU 1108, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1108, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In one implementation, the NPU 1108 is a part of one or more of the CPU 1102, the GPU 1104, and/or the DSP 1106.

In some examples, one or more of the processors of the processing system 1100 may be based on an ARM or RISC-V instruction set.

The processing system 1100 also includes a memory 1124, which is representative of one or more static and/or dynamic memories, such as a dynamic random access memory, a flash-based static memory, and the like. In this example, the memory 1124 includes computer-executable components, which may be executed by one or more of the aforementioned processors of the processing system 1100.

In particular, in this example, the memory 1124 includes a data set receiving component 1124A and a model training component 1124B. The depicted components, and others not depicted, may be configured to perform various aspects of the methods described herein.

Generally, the processing system 1100 and/or components thereof may be configured to perform the methods described herein.

FIG. 12 depicts an example processing system 1200 for predicting the layout of a spatial area using a machine learning model and an input data set of multidimensional samples, such as described herein for example with respect to FIG. 10.

The processing system 1200 includes a central processing unit (CPU) 1202, which in some examples may be a multi-core CPU. The processing system 1200 also includes additional processing components tailored to specific functions, such as a graphics processing unit (GPU) 1204, a digital signal processor (DSP) 1206, and a neural processing unit (NPU) 1208. The CPU 1202, GPU 1204, DSP 1206, and NPU 1208 may be similar to the CPU 1102, GPU 1104, DSP 1106, and NPU 1108 discussed above with respect to FIG. 11.

In some examples, the connectivity component 1212 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. The connectivity component 1212 may be further connected to one or more antennas (not shown).

In some examples, one or more of the processors of the processing system 1200 may be based on an ARM or RISC-V instruction set.

The processing system 1200 also includes a memory 1224, which is representative of one or more static and/or dynamic memories, such as a dynamic random access memory, a flash-based static memory, and the like. In this example, the memory 1224 includes computer-executable components, which may be executed by one or more of the aforementioned processors of the processing system 1200.

In particular, in this example, the memory 1224 includes a data set receiving component 1224A, a layout predicting component 1224B, a layout outputting component 1224C, and a machine learning model component 1224D (such as a machine learning model trained by system 1100 illustrated in FIG. 11). The depicted components, and others not depicted, may be configured to perform various aspects of the methods described herein.

Generally, the processing system 1200 and/or components thereof may be configured to perform the methods described herein.

Notably, in other aspects, elements of the processing system 1200 may be omitted, such as where the processing system 1200 is a server computer or the like. For example, the multimedia component 1210, the connectivity component 1212, the sensors 1216, the ISPs 1218, and/or the navigation component 1220 may be omitted in other aspects.

### EXAMPLE CLAUSES

Implementation details of various aspects are described in the following numbered clauses.

Clause 1: A computer-implemented method comprising: receiving an input data set including a plurality of samples from a spatial area, each sample of the plurality of samples including at least channel state information data; and training a machine learning model to predict a layout of the spatial area based on the input data set, wherein the predicted layout of the spatial area comprises a plurality of bounding boxes defining different regions of the spatial area.

Clause 2: The method of Clause 1, wherein the channel state information data comprises power measurements at a given location and time in a three-dimensional space.

Clause 3: The method of any of Clauses 1 or 2, wherein training the machine learning model comprises: training a first machine learning model that generates an intermediate output from the channel state information data; and training a second machine learning model that generates an attention output from time data derived from the channel state information data.

Clause 4: The method of Clause 3, wherein training the machine learning model further comprises training the machine learning model to generate a post-activation combined average based on applying an activation function to a combination of a time-averaged output of the first machine learning model and a time-averaged output of the second machine learning model.

Clause 5: The method of Clause 4, wherein training the machine learning model further comprises training the machine learning model to output information defining the predicted layout of the spatial area based on a plurality of regression heads and the post-activation combined average.

Clause 6: The method of any of Clauses 3 through 5, wherein: the time data comprises visual representations of time difference of arrival (TDoA) information for each antenna of a plurality of antennas of a wireless device associated with the channel state information data for each sample in the input data set, the first machine learning model comprises a transformer neural network, and the second machine learning model comprises a vision transformer neural network that generates the attention output from time data based on the visual representations of the TDoA information for each antenna of the plurality of antennas.

Clause 7: The method of Clause 6, further comprising generating the visual representations of the TDoA information for each antenna of the plurality of antennas based on an inverse Fourier transform of the channel state information data and a transposed version of the inverse Fourier transform of the channel state information data.

Clause 8: The method of any of Clauses 1 through 7, wherein the predicted layout of the spatial area further comprises one or more of a predicted number of regions in the spatial area, a predicted number of openings between regions in the spatial area, predicted coordinates of each region in the spatial area, and predicted coordinates of each opening between regions in the spatial area.

Clause 9: The method of any of Clauses 1 through 8, wherein: the plurality of samples comprises multidimensional samples including the channel state information data, localization data, and time data for each sample in the input data set, and training the machine learning model comprises: training a first machine learning model to generate a representation of each sample of the plurality of samples, and training a second machine learning model to generate the plurality of bounding boxes for discrete portions of the spatial area based on the representation of each sample of the plurality of samples.

Clause 10: The method of Clause 9, wherein the localization data comprises acceleration data and velocity data for a wireless device associated with the channel state information data.

Clause 11: The method of any of Clauses 9 or 10, wherein: the first machine learning model comprises a transformer encoder, and training the first machine learning model comprises training the transformer encoder to generate, from the input data set, an output sequence that identifies local correlations within sequences of samples in the input data set.

Clause 12: The method of Clause 11, wherein training the second machine learning model comprises training the second machine learning model to generate: the bounding boxes, wherein each bounding box comprises a set of coordinates in a multi-dimensional space; and a layout of the spatial area from the bounding boxes.

Clause 13: The method of Clause 12, wherein training the second machine learning model further comprises training the second machine learning model to match point sets corresponding to the coordinates of the bounding boxes based on a minimization of one or more of a Chamfer distance between the coordinates of the bounding boxes or a Hungarian loss metric corresponding to the coordinates of each bounding box of the plurality of bounding boxes, in order to generate the layout of the spatial area.

Clause 14: The method of Clause 13, wherein training the second machine learning model further comprises training the second machine learning model to minimize a mean intersection over union (IoU) measurement between the bounding boxes.

Clause 15: The method of any of Clauses 9 through 14, wherein training the machine learning model further comprises training the machine learning model to predict the layout of the spatial area based on a predicted distribution of layouts in the spatial area for the input data set.

Clause 16: The method of any of Clauses 9 through 15, wherein training the machine learning model comprises training the machine learning model to predict a distribution of layouts in the spatial area for the input data set based on a joint distribution over parameters of the machine learning model and the predicted distribution of layouts.

Clause 17: The method of Clause 16, wherein training the machine learning model comprises training the machine learning model to predict a posterior distribution over weights of the machine learning model, approximated based on a Kullback-Leibler (KL)-divergence measurement of an approximate probability distribution over the weights.

Clause 18: The method of any of Clauses 9 through 17, wherein training the machine learning model further comprises training the machine learning model to generate the bounding boxes to have non-contiguous coordinates.

Clause 19: A computer-implemented method comprising: receiving an input data set including a plurality of samples from a spatial area, each sample including at least channel state information data; predicting a layout of the spatial area based on a machine learning model and the received input data set, wherein the predicted layout of the spatial area comprises a plurality of bounding boxes defining different regions of the spatial area; and outputting the predicted layout of the spatial area.

Clause 20: The method of Clause 19, wherein the channel state information data comprises power measurements at a given location and time in a three-dimensional space.

Clause 21: The method of any of Clauses 19 or 20, wherein predicting the layout of the spatial area comprises predicting the layout based on: an intermediate output generated by a first machine learning model from the channel state information data, and an attention output generated by a second machine learning model from time data derived from the channel state information data.

Clause 22: The method of Clause 21, wherein predicting the layout of the spatial area further comprises generating a post-activation combined average based on an activation function applied to a combination of a time-averaged output of the first machine learning model and a time-averaged output of the second machine learning model.

Clause 23: The method of Clause 22, wherein predicting the layout of the spatial area further comprises generating, based on a plurality of regression heads and the post-activation combined average, information defining the predicted layout of the spatial area.

Clause 24: The method of any of Clauses 21 through 23, wherein: the time data comprises visual representations of time difference of arrival (TDoA) information for each antenna of a plurality of antennas of a wireless device associated with the channel state information data for each sample in the input data set, the first machine learning model comprises a transformer neural network, and the second machine learning model comprises a vision transformer neural network that generates the attention output from the time data based on the visual representations of the TDoA information for each antenna of the plurality of antennas.

Clause 25: The method of Clause 24, further comprising generating the visual representations of the TDoA information for each antenna of the plurality of antennas based on an inverse Fourier transform of the channel state information data and a transposed version of the inverse Fourier transform of the channel state information data.

Clause 26: The method of any of Clauses 19 through 25, wherein the predicted layout of the spatial area further comprises at least one of a predicted number of regions in the spatial area, a predicted number of openings between regions in the spatial area, predicted coordinates of each region in the spatial area, and predicted coordinates of each opening between regions in the spatial area.

Clause 27: The method of any of Clauses 19 through 26, wherein: the plurality of samples comprises multidimensional samples including the channel state information data, localization data, and time data for each sample in the input data set; and predicting the layout of the spatial area comprises: generating a representation of each sample of the plurality of samples using a first machine learning model; and generating the bounding boxes for discrete portions of the spatial area and the layout of the spatial area using a second machine learning model and the representation of each sample of the plurality of samples.

Clause 28: The method of Clause 27, wherein: the first machine learning model comprises a transformer encoder configured to generate, from the input data set, an output sequence with same dimensions as the input data set that identifies local correlations within sequences of samples in the input data set; and the second machine learning model is configured to generate: the bounding boxes, wherein each bounding box comprises a set of coordinates in a multi-dimensional space, and a layout of the spatial area from the bounding boxes.

Clause 29: A processing system comprising: a memory comprising computer-executable instructions; and one or more processors configured to execute the computer-executable instructions and cause the processing system to perform a method in accordance with any of Clauses 1-28.

Clause 30: A processing system comprising means for performing a method in accordance with any of Clauses 1-28.

Clause 31: A non-transitory computer-readable medium comprising computer-executable instructions that, when executed by one or more processors of a processing system, cause the processing system to perform a method in accordance with any of Clauses 1-28.

Clause 32: A computer program product embodied on a computer-readable storage medium comprising code for performing a method in accordance with any of Clauses 1-28.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method comprising:
receiving an input data set including a plurality of samples from a spatial area, each sample of the plurality of samples including at least channel state information data; and
training a machine learning model to predict a layout of the spatial area based on the input data set, wherein the predicted layout of the spatial area comprises a plurality of bounding boxes defining different regions of the spatial area.

2. The method of claim 1, wherein the channel state information data comprises power measurements at a given location and time in a three-dimensional space.

3. The method of claim 1, wherein training the machine learning model comprises:
training a first machine learning model that generates an intermediate output from the channel state information data; and
training a second machine learning model that generates an attention output from time data derived from the channel state information data.

4. The method of claim 3, wherein training the machine learning model further comprises training the machine learning model to generate a post-activation combined average based on applying an activation function to a combination of a time-averaged output of the first machine learning model and a time-averaged output of the second machine learning model.

5. The method of claim 4, wherein training the machine learning model further comprises training the machine learning model to output information defining the predicted layout of the spatial area based on a plurality of regression heads and the post-activation combined average.

6. The method of claim 3, wherein:
the time data comprises visual representations of time difference of arrival (TDoA) information for each antenna of a plurality of antennas of a wireless device associated with the channel state information data for each sample in the input data set,
the first machine learning model comprises a transformer neural network, and
the second machine learning model comprises a vision transformer neural network that generates the attention output from time data based on the visual representations of the TDoA information for each antenna of the plurality of antennas.

7. The method of claim 6, further comprising generating the visual representations of the TDoA information for each antenna of the plurality of antennas based on an inverse Fourier transform of the channel state information data and a transposed version of the inverse Fourier transform of the channel state information data.

8. The method of claim 1, wherein the predicted layout of the spatial area further comprises one or more of a predicted number of regions in the spatial area, a predicted number of openings between regions in the spatial area, predicted coordinates of each region in the spatial area, and predicted coordinates of each opening between regions in the spatial area.

9. The method of claim 1, wherein:
the plurality of samples comprises multidimensional samples including the channel state information data, localization data, and time data for each sample in the input data set, and
training the machine learning model comprises:
training a first machine learning model to generate a representation of each sample of the plurality of samples, and
training a second machine learning model to generate the plurality of bounding boxes for discrete portions of the spatial area based on the representation of each sample of the plurality of samples.

10. The method of claim 9, wherein the localization data comprises acceleration data and velocity data for a wireless device associated with the channel state information data.

11. The method of claim 9, wherein:
the first machine learning model comprises a transformer encoder, and
training the first machine learning model comprises training the transformer encoder to generate, from the input data set, an output sequence that identifies local correlations within sequences of samples in the input data set.

12. The method of claim 11, wherein training the second machine learning model comprises training the second machine learning model to generate:
the bounding boxes, wherein each bounding box comprises a set of coordinates in a multi-dimensional space; and
a layout of the spatial area from the bounding boxes.

13. The method of claim 12, wherein training the second machine learning model further comprises training the second machine learning model to match point sets corresponding to the coordinates of the bounding boxes based on a minimization of one or more of a Chamfer distance between the coordinates of the bounding boxes or a Hungarian loss metric corresponding to the coordinates of each bounding box of the plurality of bounding boxes, in order to generate the layout of the spatial area.

14. The method of claim 13, wherein training the second machine learning model further comprises training the second machine learning model to minimize a mean intersection over union (IoU) measurement between the bounding boxes.

15. The method of claim 9, wherein training the machine learning model further comprises training the machine learning model to predict the layout of the spatial area based on a predicted distribution of layouts in the spatial area for the input data set.

16. The method of claim 9, wherein training the machine learning model comprises training the machine learning model to predict a distribution of layouts in the spatial area for the input data set based on a joint distribution over parameters of the machine learning model and the predicted distribution of layouts.

17. The method of claim 16, wherein training the machine learning model comprises training the machine learning model to predict a posterior distribution over weights of the machine learning model, approximated based on a Kullback-Leibler (KL)-divergence measurement of an approximate probability distribution over the weights.

18. The method of claim 9, wherein training the machine learning model further comprises training the machine learning model to generate the bounding boxes to have non-contiguous coordinates.

19. A computer-implemented method comprising:
receiving an input data set including a plurality of samples from a spatial area, each sample including at least channel state information data;
predicting a layout of the spatial area based on a machine learning model and the received input data set, wherein the predicted layout of the spatial area comprises a plurality of bounding boxes defining different regions of the spatial area; and
outputting the predicted layout of the spatial area.

20. The method of claim 19, wherein the channel state information data comprises power measurements at a given location and time in a three-dimensional space.

21. The method of claim 19, wherein predicting the layout of the spatial area comprises predicting the layout based on:
an intermediate output generated by a first machine learning model from the channel state information data, and
an attention output generated by a second machine learning model from time data derived from the channel state information data.

22. The method of claim 21, wherein predicting the layout of the spatial area further comprises generating a post-activation combined average based on an activation function applied to a combination of a time-averaged output of the first machine learning model and a time-averaged output of the second machine learning model.

23. The method of claim 22, wherein predicting the layout of the spatial area further comprises generating, based on a plurality of regression heads and the post-activation combined average, information defining the predicted layout of the spatial area.

24. The method of claim 21, wherein:
the time data comprises visual representations of time difference of arrival (TDoA) information for each antenna of a plurality of antennas of a wireless device associated with the channel state information data for each sample in the input data set,
the first machine learning model comprises a transformer neural network, and
the second machine learning model comprises a vision transformer neural network that generates the attention output from the time data based on the visual representations of the TDoA information for each antenna of the plurality of antennas.

25. The method of claim 24, further comprising generating the visual representations of the TDoA information for each antenna of the plurality of antennas based on an inverse Fourier transform of the channel state information data and a transposed version of the inverse Fourier transform of the channel state information data.

26. The method of claim 19, wherein the predicted layout of the spatial area further comprises at least one of a predicted number of regions in the spatial area, a predicted number of openings between regions in the spatial area, predicted coordinates of each region in the spatial area, and predicted coordinates of each opening between regions in the spatial area.

27. The method of claim 19, wherein:
the plurality of samples comprises multidimensional samples including the channel state information data, localization data, and time data for each sample in the input data set; and
predicting the layout of the spatial area comprises:
generating a representation of each sample of the plurality of samples using a first machine learning model; and
generating the bounding boxes for discrete portions of the spatial area and the layout of the spatial area using a second machine learning model and the representation of each sample of the plurality of samples.

28. The method of claim 27, wherein:
the first machine learning model comprises a transformer encoder configured to generate, from the input data set, an output sequence with same dimensions as the input data set that identifies local correlations within sequences of samples in the input data set; and
the second machine learning model is configured to generate:
the bounding boxes, wherein each bounding box comprises a set of coordinates in a multi-dimensional space, and
a layout of the spatial area from the bounding boxes.

29. A system comprising:
a memory having executable instructions stored thereon; and
a processor configured to execute the executable instructions in order to cause the system to:
receive an input data set including a plurality of samples from a spatial area, each sample of the plurality of samples including at least channel state information data; and
train a machine learning model to predict a layout of the spatial area based on the input data set, wherein the predicted layout of the spatial area comprises a plurality of bounding boxes defining different regions of the spatial area.

30. A system comprising:
a memory having executable instructions stored thereon; and
a processor configured to execute the executable instructions in order to cause the system to:
receive an input data set including a plurality of samples from a spatial area, each sample including at least channel state information data;
predict a layout of the spatial area based on a machine learning model and the received input data set, wherein the predicted layout of the spatial area comprises a plurality of bounding boxes defining different regions of the spatial area; and
output the predicted layout of the spatial area.
